(19) United States
(12) Patent Application Publication
(10) Pub. No.: US 2005/0256603 A1
(43) Pub. Date: Nov. 17, 2005

(54) System and apparatus for cutting out custom apparel patterns from fabric

(76) Inventors: Nathan Cloud, Wilmington, DE (US); Tony Rhudd, Newark, DE (US)

Correspondence Address: AKERMAN SENTERFITT, P.O. BOX 3188, WEST PALM BEACH, FL, 33402-3188, US

(21) Appl. No.: 11/113,674

(22) Filed: Apr. 25, 2005

Related U.S. Application Data
(60) Provisional application No. 60/566,123, filed on Apr. 28, 2004.

(51) Int. Cl. G06F 19/00

(52) U.S. Cl. 700/132

(57) ABSTRACT

A system and apparatus which produces a product from a custom apparel pattern in electronic format is disclosed. The system converts custom apparel patterns in electronic format to identifiable apparel pieces ready to sew into a custom article of apparel. A projector receives digital data and projects a true image of the complete apparel pattern onto a surface over which a web of fabric has been positioned. A person is then able to identify and the pattern pieces by following the projected pattern lines, which can then be cut out by using various means including roller cutters or scissors cutters.

### CROSS-REFERENCE TO RELATED APPLICATIONS

The present application claims the benefit of priority of U.S. Provisional Patent application No. 60/566,123, filed Apr. 28, 2004; and entitled SYSTEM AND APPARATUS FOR CUTTING OUT CUSTOM APPAREL PATTERNS FROM FABRIC, which is incorporated herein by reference in its entirety.

### BACKGROUND

Apparel is supplied to the marketplace by a series of steps that includes the step of cutting out a pattern from a sheet or web of flexible fabric material. The ‘cutting out’ step in producing “custom” or “designer prototype” apparel is usually done manually with a hand held cutting tool after the apparel pattern has been defined on a sheet or web of fabric. Mass production techniques include cutting multiple layers at the same time with hand held power tools, or by more automated computer controlled machines using various means to cut the fabric including lasers, water jets, or knives. While these more automated systems may be used for “custom supply chains”, hereinafter referred to as “Unit order of one” (UO1), automated means are typically not cost effective (productive) for such custom supply chains because the machine systems cannot cut out UO1's (single fabric layer) fast enough to justify their high investment. On the other hand, custom or design prototype supply methods are very tedious and labor intensive and are consequently expensive for the final consumer and/or cannot respond quickly enough to an impatient marketplace.

State of the art automated laser cutters can cut out a pattern, such as the jeans pattern depicted in FIGS. 2 & 3, from a single layer of fabric in approximately 2 minutes, but these machines require an investment of on the order of $1-2K., and they require some manual attention. Current manual cutting methods are labor intensive because they require some means of transferring the pattern to the web of material—either by the old “tailor” method of “laying out” the pattern with chalk, or by printing the pattern from an electronic data base onto a paper sheet which is then affixed to the web of fabric for cutting. This process can take on the order of 20-30 minutes even when cutting is done in parallel with printing. The time difference between these methods and what will be described as the present invention is significant in developed countries at labor rates on the order of $10/hr. In underdeveloped countries where labor rates might be on the order of $1.00/hr the added material costs of paper and glue become significant in comparison with the present invention which requires no additional peripheral material costs.

### SUMMARY OF THE INVENTION

It is the primary object of the subject invention to produce a system which can quickly and economically produce a “Unit order of one” (UO1) in such manner as to be cost-effective.

It is a related object to develop a system which produces a product from a custom apparel pattern in electronic format.

It is still another object of the subject invention to provide a suitable backing onto which fabric may be placed, as electronic images are directed onto the fabric.

It is yet one more object of the subject invention to provide such a backing which is particularly adapted to be used with roller cutters or scissor cutters.

In accordance with the objects of the subject invention, a system is developed which converts custom apparel patterns in electronic format to identifiable apparel pieces ready to sew into a custom article of apparel. The system consists of a projector, which receives digital data; and which projects a true image of the complete apparel pattern onto a surface over which a web of fabric has been positioned; further the system provides the means such as a person to identify, and cut out the pattern pieces, by following the projected pattern lines, and by using various means including roller cutters, or scissors cutters.

In one embodiment, a cutting surface provides stable positioning for webs of fabrics by utilizing a “self healing” polymeric sheet for a roller cutter. A vacuum is created behind the sheet within a plenum by a simple blower fan. A further alternate means provides a cutting surface which consists of a porous short bristle “carpet” like material behind which a vacuum is created within a plenum by a simple blower fan. The backing provides stable positioning for the fabric web which can then be cut by a scissor cutter.

### BRIEF DESCRIPTION OF THE DRAWINGS

FIG. 1 overall block diagram of unit order supply chain.

FIG. 2 is a schematic view of a typical apparel pattern for jeans.

FIG. 3 shows the schematic of FIG. 2 as projected onto a cutting surface.

FIG. 4 shows the schematic of FIG. 2 as projected onto a modified embodiment of a cutting surface.

### DETAILED DESCRIPTION

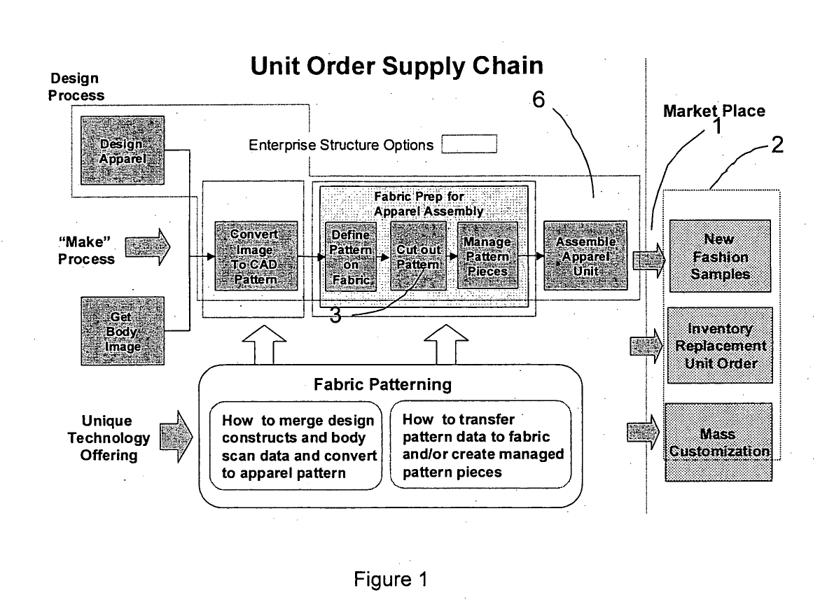

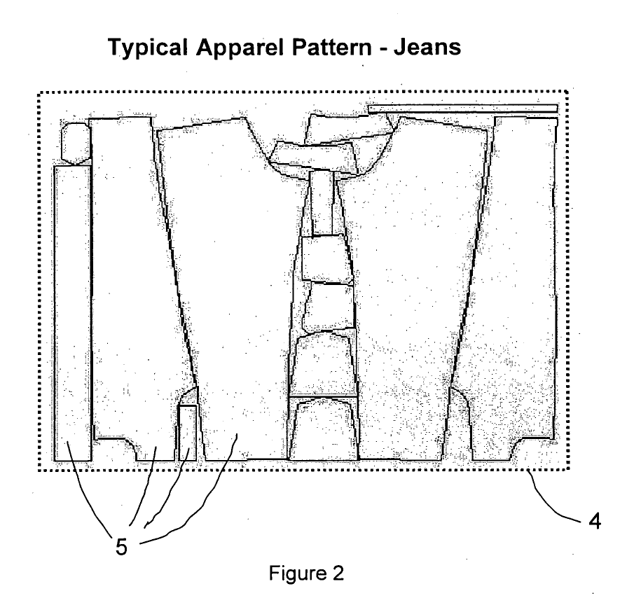

With reference to FIG. 1, the pattern cutting step 3 in such UO1 supply chain assumes that a custom or designer pattern has been created, and has been converted electronically to a planer image 4 of pattern pieces 5 such as that shown in FIG. 2. It is further assumed that the supply chain step after cutting is sewing 6 the pieces together, and that this step requires identification of the cut pieces. One or both of these steps before and after cutting and piece identification may or may not be carried out in the geographic proximity of the cutting and piece identification.

The present invention focuses on a means to project the true shape pattern image 5 of an article of apparel onto a planer surface so that the pattern pieces 4 may be identified and cut out and packaged for subsequent assembly by a means such as sewing.

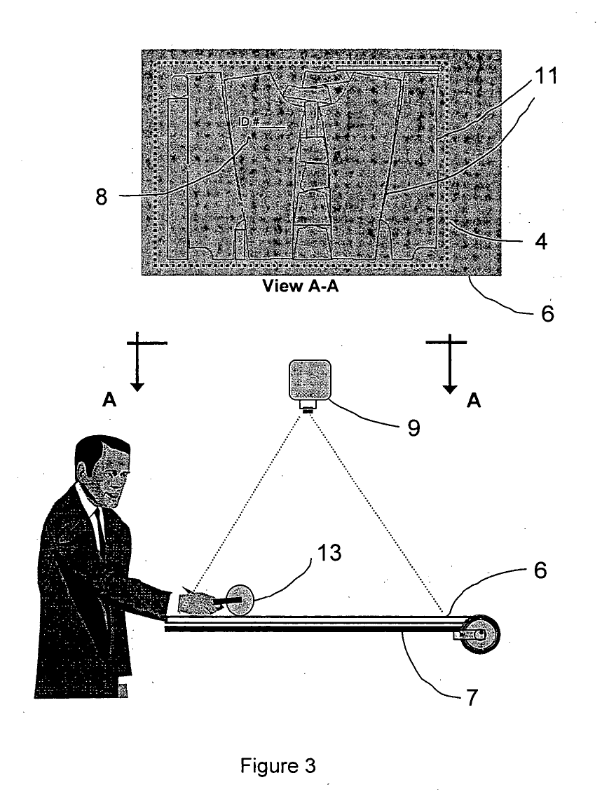

With reference to FIG. 3, the simple operation is described as follows:

A web of fabric 6 is pulled quickly across a cutting surface 7 and held in position by clamping or vacuum or other means.

The electronic image 5 of an apparel pattern and piece identification 8 are projected onto the surface of the fabric web by an electronic projector 9 coupled to a computer in which resides the electronic image of the pattern.

A human cuts out the pattern pieces by moving a cutting tool 10 along the pattern lines 11 that are projected onto the fabric web.

The human affixes a piece identification code to each pattern piece and removes the pattern pieces from the cutting surface.

The pattern pieces with identification are then packaged for subsequent assembly steps.

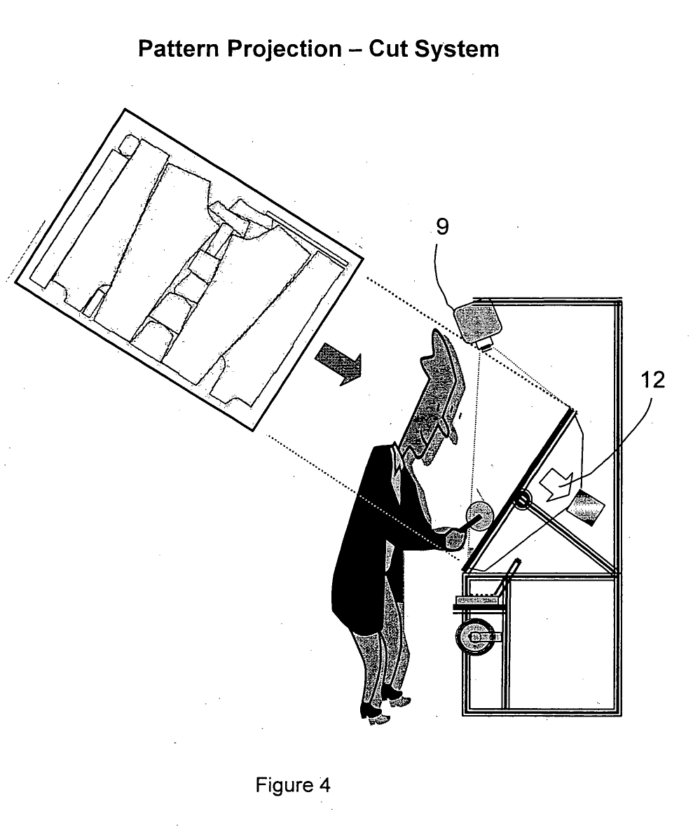

In a more sophisticated embodiment, the human of steps 3) and 4) above may be replaced by laser cutters of other comparable means, which are calibrated to cut the projected pattern on the fabric web. A physical embodiment of the present invention is depicted in FIG. 4. A projector 9 is positioned generally over the cutting surface in an orientation that minimizes occlusion of the image by the person cutting out the pattern pieces. Two synchronized cameras may be employed to minimize the occlusion, but it has been found that a human through brief memory interpolation of the pattern line can accommodate some occlusion from a single camera.

The fabric web is held in position by means of clamps along the edges of the web, or continuously across the web surface by means of vacuum 12 underneath the web. The cutting surface may be oriented in a horizontal plane or, in the case of a continuous holding method, angled for better ergonomic cutting position.

The cutting surface may consist of a “self healing” polymeric material in conjunction with a “pizza wheel” cutter 13 commonly used for apparel cutting today. An alternative cutting surface, which may be employed, is a backing material from which short bristles protrude. This enables scissors, either manual or automatic to be rapidly moved along the pattern line without changing the position of the fabric.

The method so described provides superior operational economics at equivalent cut quality to current methods, either as a separate business entity in the overall custom apparel supply chain or as an integral step in such a supply chain.

1. An improved method of producing a Unit Order of One of custom apparel patterns to be subsequently sewn together to form custom apparel and where CAD patterns based on body images have been provided, comprising the steps of:
securing and stabilizing fabric onto a cutting surface;
projecting the CAD pattern onto the fabric; and
cutting out the CAD pattern from the fabric into identifiable pattern pieces.

2. The method of claim 1 wherein the step of cutting out the CAD pattern from the fabric is done by a human.

3. Apparatus for producing a Unit Order of One custom apparel patterns to be subsequently sewn together to form apparel, and where CAD patterns are provided, comprising:
a projecting means to project the CAD patterns onto a fabric;
a cutting surface for placing the fabric onto which CAD patterns are projected;
means to stabilize the fabric on the cutting surface when cutting; and
means to allow rapid and accurate cutting by various means while fabric and cut pieces remain stabilized.

4. The apparatus of claim 2 wherein the means to secure the fabric to the cutting surface include clamps.

5. The apparatus of claim 2 wherein the means to cut out the fabric with conventional scissors includes protruding short bristles to allow the scissors to engage the fabric while not disturbing it's position.

6. The apparatus of claim 2 wherein the means to cut out the fabric with “pizza wheel” scissors includes a “self healing” polymeric surface.

7. The apparatus of claim 2 wherein the means to secure and stabilize the fabric onto the cutting surface includes vacuum means.

8. The apparatus of claim 5 wherein the vacuum means comprises a plenum and blower fan positioned on the opposite side of the cutting surface from the projecting means; and a porous fabric stabilzation surface

9. An improved method of producing a Unit Order of One of custom apparel comprising the steps of:
obtaining a body image for use in designing apparel;
converting the body image to a CAD pattern;
projecting the CAD pattern onto a fabric;
cutting out the CAD pattern from the fabric(s) into identifiable pattern pieces; and
assembling the pattern pieces into custom apparel.
